(19) United States
(12) Patent Application Publication
(10) Pub. No.: US 2012/0024978 A1
(43) Pub. Date: Feb. 2, 2012

(54) WATER FOUNTAIN SYSTEM INCLUDING A MEANS FOR PROPELLING FLOATING ORNAMENTS

(76) Inventor: Rinoud Hanna, Rochester, NY (US)

(21) Appl. No.: 13/211,552

(22) Filed: Aug. 17, 2011

Related U.S. Application Data
(63) Continuation-in-part of application No. 12/804,821, filed on Jul. 30, 2010, now abandoned.

(51) Int. Cl. B05B 17/08

(52) U.S. Cl. 239/17

(57) ABSTRACT

A fountain system having at least one fountain head and an apparatus for propelling floating ornaments on the water surface of a body of water. The fountain system includes a submersible water pump having a means for securing the unit below the water surface level. Connected to the output of the submersible water pump is a three-way connector for diverting a portion of the output water flow to a fountain head with the remaining portion directed to an elongated L-shaped assembly for producing a circulating water current configured to propel floating ornaments located on the water surface. A variation of the present invention includes the means for adjusting circulating water current direction and/or distance from water surface so that floating ornament motion characteristics are adjustable. Yet another variation of the present invention includes a polymeric generally circular floatation ring that provides an inner boundary area within a larger body of water wherein the floating ornaments are permitted to circulate.

### CROSS-REFERENCE TO RELATED PATENT APPLICATION

This patent application is a continuation-in-part of applicants' co-pending patent application Ser. No. 12/804,821, filed Jul. 30, 2010.

### FIELD OF THE INVENTION

The present invention relates to a decorative water fountain system that includes an open body of water, or pool; and more particularly to a fountain system including a means for imparting motion to floating ornaments thereon.

### DESCRIPTION OF RELATED ART

There are a multitude of decorative fountain designs. Fountains can be situated in natural bodies of water such as ponds or lakes. Other fountain designs are configured from artificial or man-made pools, ponds, or the like. For example, commercially available fountains having circular type pools are common place and are readily available. Some fountain designs divert a portion of the fountain total water flow into a fixed water stream that is directed to the ornaments floating about the pool to provide an impetus for imparting motion thereof; still others utilize a fixed dedicated pump to provide such motion. Such motion inducing mechanisms tend to produce floating ornament movements or motions that are inappropriate or undesirable for a fountain pool. Inappropriate or undesirable ornament motions include ornament clustering, stalled ornaments, and the like. Such undesirable ornament motion associated with common fountain systems is an ever-present issue in need of efficacious solutions.

### SUMMARY OF THE INVENTION

The present invention is directed to a fountain system associated with an open body of water capable of inducing desirable motion to floating ornaments thereon utilizing a motion inducing water current. The means for generating a circulating water current or motion inducing water current is comprised of an apparatus that is configured from an elongated L-shaped tube having an end corner connection for directing the motion inducing water current. The water supplied to the elongated L-shaped tube is parceled from the output of a submersible water pump.

Accordingly, it is an object of the present invention to provide a water current to the pool portion of a fountain system for inducing motion to floating ornaments located on the pool's water surface, wherein the boundary of the pool is curvilinear so to reduce/eliminate dead spots or eddies that may hinder ornament motion.

It is another object of the present invention to provide a polymeric generally circular floatation ring placed onto a larger body of water or pond so that an inner boundary area is created within a larger body. The inner boundary area provides a water surface where the floating ornaments are permitted to circulate.

It is yet another object of the present invention to provide a submersible water pump rigidly attached to the motion inducing water current member; where the submersible water pump is adjustable with respect to the water surface and/or pool wall so to provide a means for adjusting the motion characteristics of the floating ornaments via the circulating water current or motion inducing water current.

It is yet another object of the present invention to provide a separate dedicated submersible water pump for inducing a motion water current. The submersible water pump, and associated pump's water exhaust, is adjustable with respect to the water surface and/or pool wall, thereby providing a means for adjusting the motion characteristics of the floating ornaments.

It is yet another object of the present invention to provide an elongated L-shaped tube having an exhaust port that is adjustable with respect to the curvilinear boundary of the water surface so to provide a means for adjusting the motion characteristics of the floating ornaments via the circulating water current or motion inducing water current.

It is yet another object of this invention to provide a relatively simple device that is economical from the viewpoint of the manufacturer and consumer, is susceptible of low manufacturing costs with regard to labor and materials, and which accordingly is then susceptible of low prices for the consuming public, thereby making it economically available to the buying public.

Whereas there may be many embodiments of the present invention, each embodiment may meet one or more of the foregoing recited objects in any combination. It is not intended that each embodiment will necessarily meet each objective.

Thus, having broadly outlined the more important features of the present invention in order that the detailed description thereof may be better understood, and that the present contribution to the art may be better appreciated, there are, of course, additional features of the present invention that will be described herein and will form a part of the subject matter of this specification.

In this respect, before explaining at least one embodiment of the invention in detail, it is to be understood that the invention is not limited in its application to the details of construction and the arrangements of the components set forth in the following description or illustrated in the drawings. The present invention is capable of other embodiments and of being practiced and carried out in various ways. Also it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent construction insofar as they do not depart from the spirit and scope of the conception regarded as the present invention.

### PARTICULAR ADVANTAGES OF THE INVENTION

The present invention provides a floating ornament fountain system configuration that lends itself to low cost due to the sharing of resources and multi-functionality of subsystems and components used. Additionally, various embodiments are disclosed that provides users with the means to manipulate the motion characteristics of floating ornaments. There are numerous characteristic motions that floating ornaments (residing on the pool portion of fountain systems) can exhibit. Motion characteristics are dictated by numerous variables which include, water depth, pool size and geometry, water pump size and location; ornament size, number, geometry; and the like. One aspect of the present invention provides a means for adjusting ornament motion characteristics. The teachings disclosed are especially valuable for lower cost fountain systems wherein less complex, low cost components are welcome.

### BRIEF DESCRIPTION OF THE DRAWINGS

The invention will be better understood and objects other than those set forth above will become apparent when consideration is given to the following detailed description thereof. Such description makes reference to the annexed drawings, in which like numerals refer to like elements, and wherein:

FIG. 1 illustrates a sectional side view of a circular pond containing a water flow management apparatus comprised of a submersible water pump, a three-way connector, a fountain head, and an L-shaped tube assembly.

FIG. 2a illustrates a top view of a generally circular, polymeric floatation ring or foam ring used in certain fountain system embodiments for providing a corral or boundary for floating ornaments.

FIG. 2b illustrates a side view of a water flow management apparatus comprised of an adjustable submersible water pump system, a foam ring, and an L-shaped tube assembly.

The drawings are not to scale, in fact, some aspects have been emphasized for a better illustration and understanding of the written description.

### PARTS/FEATURES LIST

1. circular pond, pool, or body of water

2. fountain

3. submersible pump

4. fountain head

5. tube

6. tube

7. water surface or water level with respect to floor 14

8. elongated L-shaped tube apparatus

9. long tube

10. short tube

11. ninety degree elbow

12. three-way connector

13. corner connector or ninety degree elbow

14. floor of pond, pool, or body of water

15. foam ring

16. water management stand assembly

17. stand, column, or vertical support section of water management stand assembly 16

18. upper clamp

19. lower clamp

### DETAILED DESCRIPTION

With reference to the drawings of the present invention, several embodiments of the fountain and associated subsystems or components thereof will be described. In describing the embodiments illustrated in the drawings, specific terminology will be used for the sake of clarity. However, the invention is not intended to be limited to the specific terms so selected, and it is to be understood that each specific term includes all technical equivalents that operate in a similar manner to accomplish a similar purpose.

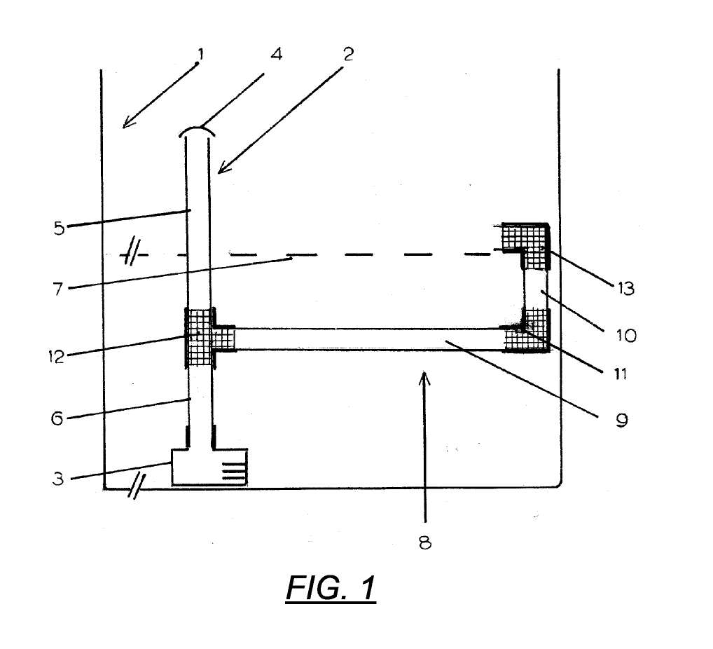

FIG. 1 illustrates a sectional side view of a pond 1 containing a water flow management apparatus comprised of a submersible water pump 3, a three-way connector 12, a fountain head 4, and an L-shaped tube assembly 8.

Again referring to FIG. 1, depicted is a three-way connector 12 having a lower end, an opposing upper end, and a side port perpendicularly disposed with respect to both the upper and side end; submersible water pump 3 possesses an input port and an output port, including a pump mount for immobilizing the unit below water level 7. The output port of pump 3 is tubularly connected to the lower end of three-way connector 12, while the upper end of connector 12 is tubularly connected to fountain head 4. Elongated L-shaped assembly 8 is comprised of horizontal long tube 9 where one end is tubularly connected to the side port of said three-way connector 12; and opposing end of horizontal long tube 9 is attached to a water directing assembly comprising a lower ninety degree elbow connector 11, an upper ninety degree elbow connector 13 possesses a water exhaust port; a lower port, and a vertical short tube 10 attached thereon. The output end of horizontal long tube 9 is connected to the lower port of lower ninety degree elbow connector 11, and the upper port of lower ninety degree elbow connector 11 is connected to the bottom end of vertical short tube 10, where the top end of vertical short tube 10 is tubularly connected to the lower port of upper ninety degree elbow connector 13.

In an alternate fountain system embodiment depicted in FIG. 1 includes, an adjustable tubular coupling means for supporting upper ninety degree elbow connector 13 onto the top end of vertical short tube 10. Adjustability can be accomplished by a variety of means, including a rotatable coupling, where water exhaust port is permitted to revolve.

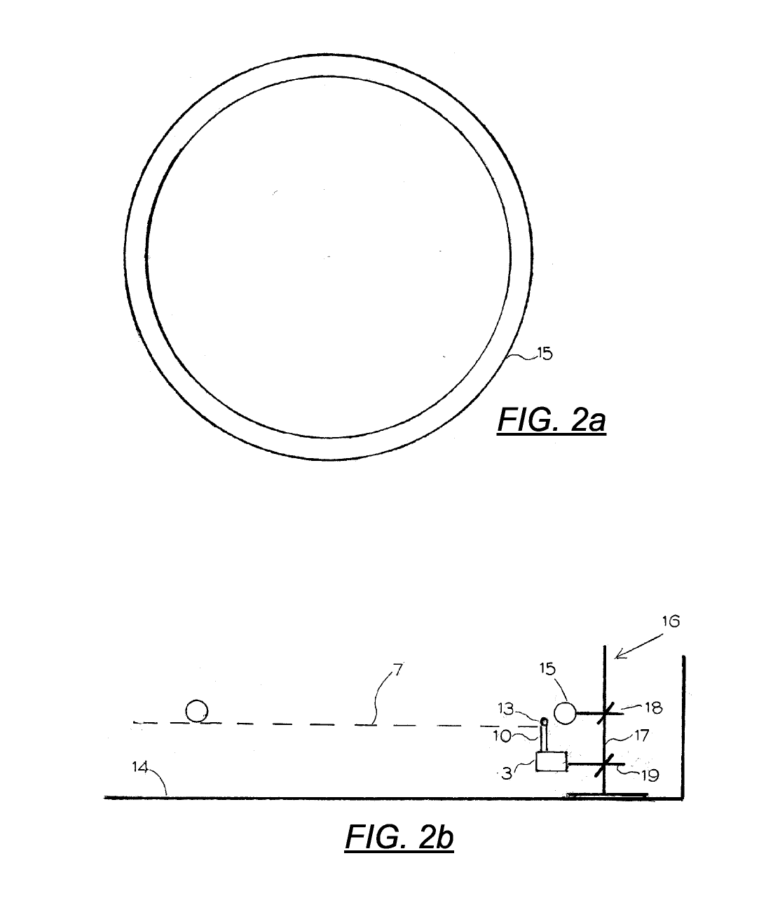

FIG. 2a illustrates a top view of a circular, polymeric floatation ring or foam ring 15. Foam ring 15 is used in certain fountain system embodiments to provide a corral or boundary for floating ornaments within a larger body of water. The foam ring 15 is placed on the water surface 7 of a body of water 1, and is held in place by upper clamp 18 (depicted in FIG. 2b).

FIG. 2b illustrates a side view of a water flow management apparatus comprised of an adjustable submersible water pump system 3, a foam ring 15, and an L-shaped tube assembly 8. Depicted is one example of an adjustable submersible water pump 3 configuration. This configuration includes a vertically adjustable pump upper clamp 18, and adjustable pump lower clamp 19 that are both releasably engaged to support stand 17. Support stand 17 includes a base or lower support end designed to engage with floor 14 of body of water 1 to provide stability to the system (prevent movement). A vertical support column 17 is configured to adjustably receive vertically adjustable ring upper clamp 18 so to permit the adjustment and retainment of ring 15 with respect to said water surface 7. It is suggested that a ring 15 have a diameter of several feet and be constructed from a material that is capable of floating on water.

The following are the details of an example fountain system that was fully tested. A circular pool 1 was constructed from a plastic material having a diameter of about 3 feet. The system included a fountain 2 that was driven by submersible pump 3 having a pumping capacity of about 170 gallons per hour. An elongated L-shaped tube 8 was attached to the three-way connector 12. All the tubes, pipes, and connectors in the functional example were one half of an inch in diameter and fabricated from CPVC (chlorinated polyvinyl chloride). It is understood that there exist numerous other materials that are capable of functioning equally well such as copper, glass or PVC (polyvinyl chloride), and the like.

The fountain head 4 was connected to submersible pump 3 via tubes 5 and 6 which are joined together by connector 12. Tube 6 was about 6 inches in length but it could be replaced by other tubes of different lengths.

Regarding elongated L-shaped tube assembly 6, the length of long tube 9 was between 12-18 inches, and the length of short vertical tube 10 was approximately 3-4 inches. All the connections were not glued so that tubes and connectors could be rotated and/or replaced at will. For example, the corner connector (90 elbow) (13) could be manipulated to direct the water flow from its exit port to the wall of the pool 1.

It is understood that the pumping capacity of submersible pump 3 can be varied as can any of the tube diameters in the system to adjust the water flow characteristics to the fountain components, i.e. head and elongated L-shaped tube assembly 6.

A second submersible pump dedicated to the generation of circulating water currents or motion inducing water currents was also tested. Adjusting the motion characteristics of floating ornaments was successfully accomplished by varying the location, and component positioning of elongated L-shaped tube assembly 6 attached to dedicated second submersible pump. Alternatively, adjusting the output port of a second submersible pump itself is another option. The second submersible pump would function as a stand-alone independent unit, free of any tubular attachments. This embodiment also proved to be an effective means for adjusting the motion characteristics of floating ornaments. Due to the cost, additional hardware, and assembly associated with the second submersible pump, this configuration is likely to be more expensive option; additionally, having a secondary submersible pump near the water surface 7 will likely result in other disadvantages, including, audible pump noise, undesirable view of the secondary pump by spectators, and the like.

In general, the present invention can be powered by ordinary commercial electric power as well as generator or battery power. Safely configuring electrical power to underwater components is well known art that is commonly practiced. Additionally, the overall motion characteristics of floating ornaments can be configured to have either a clockwise or counter-clockwise disposition.

What is claimed herein is:

1. A fountain system having at least one fountain head (4) for directing water above a water level (7), said fountain system, comprising:
an apparatus for propelling floating ornaments on a water surface of a pond (1), said water surface includes a curvilinear boundary wherein said floating ornaments are confined, said apparatus, comprising:
a three-way connector having a lower end, an opposing upper end, and a side port perpendicularly disposed with respect to both said upper end and said side end, and
a submersible water pump having an input port and an output port, including a pump mounting means for immobilizing said submersible water pump below said water level (7), said output port of said pump tubularly connected to said lower end of said three-way connector; said upper end of said three-way connector tubularly connected to said at least one fountain head (4), and
an elongated L-shaped assembly for directing a circulating water current whereby said floating ornaments are propelled, said elongated L-shaped assembly, comprising: a horizontal long tube (9) having an input end and an output end wherein said input end is tubularly connected to said side port of said three-way connector; and
a water directing assembly comprising a lower ninety degree elbow connector (11) having an upper port and a lower port; an upper ninety degree elbow connector (13) having a lower port and a water exhaust port; and a vertical short tube (10) having a top end and a bottom end;
said output end of said horizontal long tube (9) is connected to said lower port of said lower ninety degree elbow connector (11), and said upper port of said lower ninety degree elbow connector (11) is connected to said bottom end of said vertical short tube (10), said top end of said vertical short tube (10) is tubularly connected to said lower port of said upper ninety degree elbow connector (13) using a tubular coupling means.

2. The fountain system of claim 1, wherein said curvilinear boundary of said water surface is further defined by a polymeric generally circular floatation ring, providing an inner boundary area within larger said water surface of a pond (1) wherein the floating ornaments are permitted to circulate.

3. The fountain system of claim 1, wherein said mounting means for immobilizing said submersible water pump includes a vertically adjustable pump clamp, said vertically adjustable pump clamp is releasably connected to a support stand (17); said stand (17) including a lower support end adapted to engage with the floor (14) of said pond (1), and a vertical post configured to adjustably receive said vertically adjustable pump clamp such that rigidly linked said water exhaust port is vertically is adjustable with respect to said water surface of said pond (1).

4. The fountain system of claim 1, wherein said tubular coupling means for supporting said upper ninety degree elbow connector (13) onto said top end of said vertical short tube (10) further includes a rotatable coupling, wherein said water exhaust port is rotatably adjustable with respect to said curvilinear boundary of said water surface.

5. The fountain system of claim 2, wherein said mounting means for immobilizing said submersible water pump includes a vertically adjustable pump clamp, said vertically adjustable pump clamp is releasably connected to a support stand (17);
said stand (17) including a lower support end adapted to engage with the floor (14) of said pond (1), and a vertical post configured to adjustably receive said vertically adjustable pump clamp such that rigidly linked said water exhaust port is vertically is adjustable with respect to said water surface of said pond (1).

6. The fountain system of claim 2, wherein said tubular coupling means for supporting said upper ninety degree elbow connector (13) onto said top end of said vertical short tube (10) further includes a rotatable coupling, wherein said water exhaust port is rotatably adjustable with respect to said curvilinear boundary of said polymeric generally circular floatation ring.

7. The fountain system of claim 6, wherein said mounting means for immobilizing said submersible water pump includes a vertically adjustable pump clamp, said vertically adjustable pump clamp is releasably connected to a support stand (17); said stand (17) including a lower support end adapted to engage with the floor (14) of said pond (1), and a vertical post configured to adjustably receive said vertically adjustable pump clamp such that rigidly linked said water exhaust port is vertically is adjustable with respect to said water surface of said pond (1).
